(19) United States
(12) Patent Application Publication
(10) Pub. No.: US 2012/0281145 A1
(43) Pub. Date: Nov. 8, 2012

(54) LEAST SQUARES MATRIX COMPRESSION AND DECOMPRESSION IN A DIGITAL TELEVISION RECEIVER

(76) Inventors: Raúl Alejandro Casas, Doylestown, PA (US); Stephen Biracree, Rochester, NY (US); Anand Mahendra Shah, San Franciso, CA (US); Slobodan Simovich, San Francisco, CA (US); Thomas Joseph Endres, Seattle, WA (US)

(21) Appl. No.: 13/465,994

(22) Filed: May 7, 2012

Related U.S. Application Data
(60) Provisional application No. 61/483,337, filed on May 6, 2011.

(51) Int. Cl. H04N 5/21

(52) U.S. Cl. 348/607; 348/E05.077

(57) ABSTRACT

The current application is directed to reducing the implementation cost of least squares (LS) channel estimation in a digital communications receiver. An inverse correlation matrix is compressed on a per-diagonal basis for low cost storage in the receiver. The inverse correlation matrix is decompressed and utilized online on a per-diagonal basis.

### CROSS-REFERENCE TO RELATED APPLICATION

This application claims the benefit of U.S. Provisional Application No. 61/483,337, filed May 6, 2011.

### TECHNICAL FIELD

The current application is directed to reducing the implementation cost of least squares (LS) channel estimation in a digital communications receiver. An inverse correlation matrix is compressed on a per-diagonal basis for low cost storage in the receiver. The inverse correlation matrix is decompressed and utilized online on a per-diagonal basis.

### BACKGROUND

Modern digital communications systems use sophisticated modulation and coding approaches to combat severe physical-layer distortions and still deliver high-throughput, low error-rate services to consumers. For example, Digital Television (DTV) in the U.S. uses signaling according to the ATSC A/53 Standard, (available in six parts at http://www.atsc.org/cms/index.php/standards/published-standards/) radiating an RF terrestrial broadcast that pushes 19.3 Mbps in a 6 MHz bandwidth through a VHF/UHF channel. Other global DTV standards are similar. This combination of throughput and propagation medium, coupled with increasing demand for services to mobile users, can impart significant dynamic distortions to the radiated broadcast, as witnessed by the consumer device.

DTV systems rely on advanced equalization strategies to remove the distortions in the received signal. Equalizer structures vary according to the type of transmission technique. Receivers for packet-based transmissions, such as the ATSC M/H Mobile DTV standard, use indirect equalization whereby a channel impulse response is estimated from a sequence of periodically transmitted known data and subsequently inverted to yield equalizer coefficients. Channel estimation and inversion may involve high computational and memory overheads which translate to a high implementation costs.

### SUMMARY

The current application is directed to reducing the implementation cost of least squares (LS) channel estimation. A LS channel estimator may involve a large amount of memory for storage of an inverse correlation matrix. The current application is also directed to providing methods for compressing the inverse correlation matrix on a per-diagonal basis for low cost storage in the receiver and for online decompression and multiplication of the matrix with cross-correlation data on a per-diagonal basis.

### BRIEF DESCRIPTION OF DRAWINGS

FIG. 1 shows a typical prior art digital television broadcast communication system.

FIG. 2 shows a typical prior art DTV receiver system.

FIG. 3 shows a prior art DTV receiver system.

FIG. 4 shows a prior art channel identification.

FIG. 5 shows a grayscale image of the inverse correlation matrix.

FIG. 6 shows a matrix compression.

FIG. 7 shows a compressed matrix database.

FIG. 8 shows a channel identification.

FIG. 9 shows a matrix reconstruction and multiplication.

### DETAILED DESCRIPTION

The current application is directed to reducing the implementation cost of least squares (LS) channel estimation. A LS channel estimator may involve a large amount of memory for storage of an inverse correlation matrix. The current application is also directed to providing methods for compressing the inverse correlation matrix on a per-diagonal basis for low cost storage in the receiver and providing methods of online decompression and multiplication of the matrix with cross-correlation data on a per-diagonal basis.

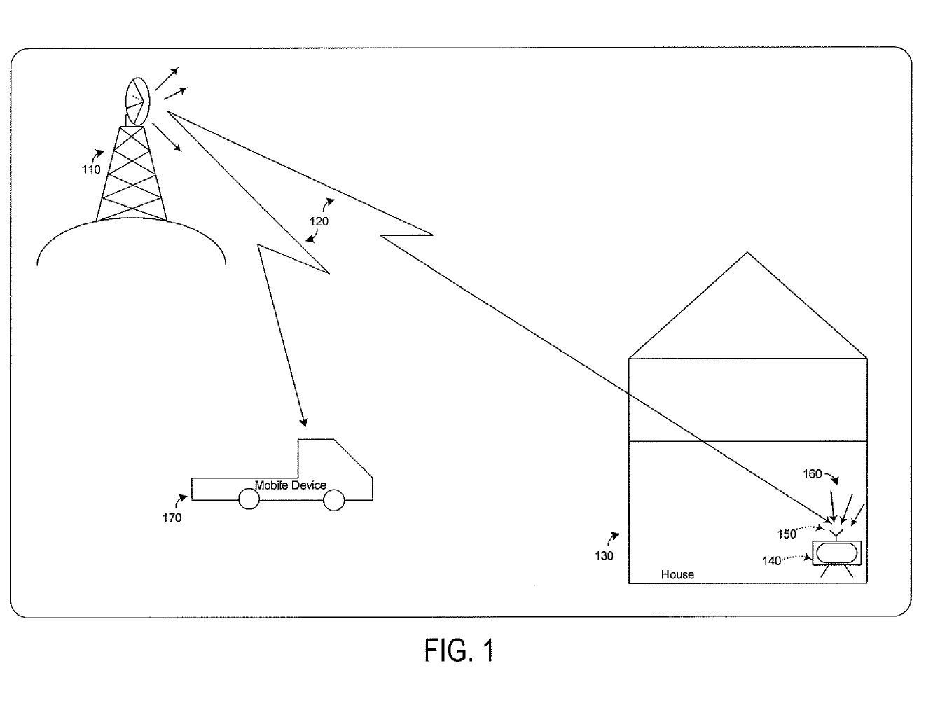

FIG. 1 depicts a typical prior art digital television broadcast communication system. Transmitter station 110 broadcasts Digital Television (DTV) signal 120, which radiates through house 130 to antenna 150, and to mobile device 170. The induced penetration loss of the RF carrier's signal power through house 130 can be significant, easily 20 dB. Antenna 150 is usually in close proximity to television 140, or can be remotely connected (wired or wireless) to television 140. Antenna 150 also receives multipath signals, collectively 160, which can be caused by reflections from other buildings, or items interior to house 130, such as walls, furniture, persons, etc. Broadcast signal 120 also radiates to mobile device 170. Mobile device 170 may be a vehicle with a television receiver in it, or a person with a mobile media player or smart phone, or any receiver which is in motion relative to transmitter station 110. Because of this relative motion, broadcast signal 120 which reaches mobile device 170 undergoes a Doppler shift, which is tracked by the receiver in mobile device 170. This Doppler shift can be significant, and its statistics dynamic.

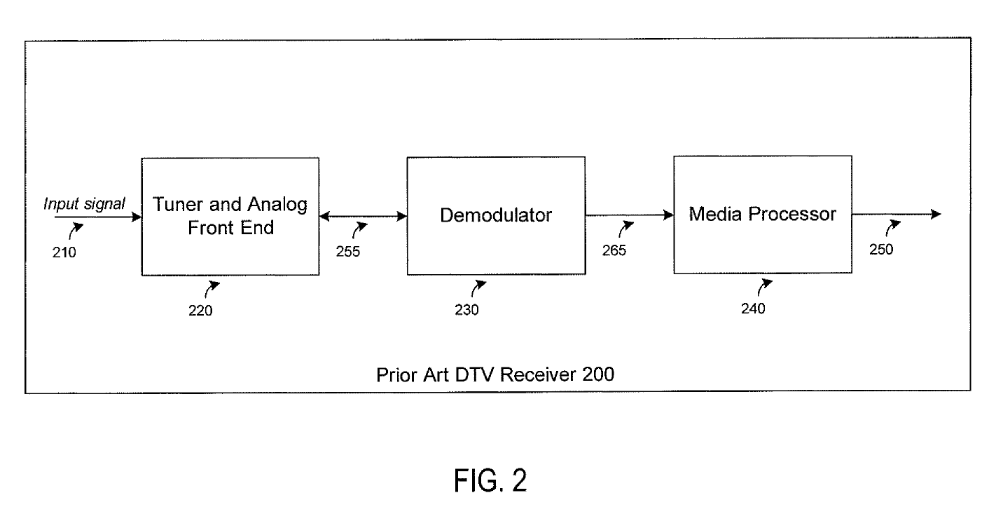

FIG. 2 shows a typical prior art DTV receiver system 200. Input signal 210 can come from an antenna, cable, computer drive, etc. In the case of the prior art digital television broadcast communication system depicted in FIG. 1, input signal 210 is comprised of broadcast DTV signal 120 and multipath signals 160. Input signal 210 is coupled to

Tuner and Analog Front End module 220. Tuner and Analog Front End module 220 may be implemented as discrete components, silicon dice, or a combination. Tuner and Analog Front End module 220 tunes to the proper broadcast channel, performs level setting and filtering, digitizes the analog signal, and supplies the bit stream to Demodulator 230 via bi-directional connection 255. Demodulator 230 is usually implemented in silicon, and performs a multiplicity of tasks to recover the encoded DTV data, including frequency translation, filtering, symbol timing, carrier frequency synchronization, equalization, and forward error correction. Demodulator 230 recovers the data bits encoded into DTV Signal 120, and is coupled to Media Processor 240 via connection 265. Media Processor 240, among other functions, interprets the data bits from demodulator 230 and renders the multimedia content for display, indicated by output signal 250. Media Processor 240 is usually implemented on the same silicon as demodulator 240, but not always.

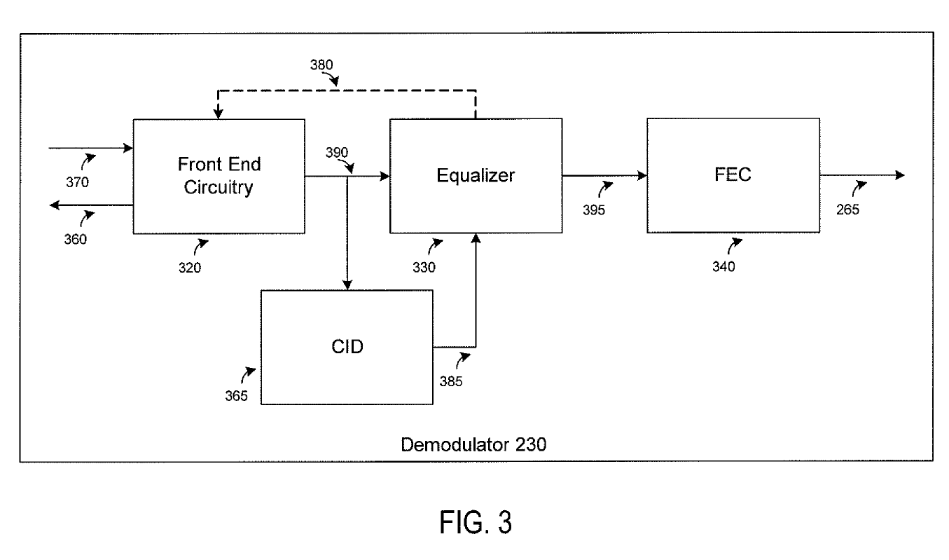

FIG. 3 shows a typical prior art demodulator 230, introduced in FIG. 2. Demodulator 230 is applicable to DTV signals using single-carrier or multi-carrier modulation techniques. Bi-directional connection 255 from FIG. 2 is comprised of input signal 370 and output signal 360 in FIG. 3. Input signal 370 comes from Tuner and Analog Front End module 220 and is coupled to Front End Circuitry 320. Front end circuitry 320 receives input signal 370 and performs a variety of tasks needed for band pass signal isolation, for example, automatic gain control, quadrature demodulation, carrier and timing synchronization, and pilot tracking, as needed. See H. Meyr, M. Moeneclaey, and S. A. Fechtel, Digital Communication Receivers, New York, N.Y.: John Wiley and Sons, 1998, for a description of front-end circuitry methods used for band pass signal isolation. Output signal 360 from Front End Circuitry 320 contains control signals for conditioning of the analog input signal prior to digitization, for example, level setting and/or frequency control, derived in Front End Circuitry 320 from the data signal, and coupled to Tuner and Analog Front End module 220. Front End Circuitry 320 also receives control signal 380 from Equalizer 330, shown in phantom, since it is not used in many applications. Control signal 380 may contain synchronization adjustments derived in equalizer 330, based on a variety of known methods. For example, Y. Mostofi and D. C. Cox, “A Robust Timing Synchronization Design in OFDM Systems—Part II: High-Mobility Cases,” IEEE Transactions on Wireless Communications, vol. 6, no. 12, pp. 4340-4348, December 2007, derives timing adjustments from pilot tones, while K. H. Mueller and M. Muller, “Timing Recovery in Digital Synchronous Data Receivers,” IEEE Transactions on Communications, vol. COM-24, no. 5, pp. 516-531, May 1976, uses symbol estimates themselves to derive a timing control signal, and it is typical in OFDM systems to use correlation against training data to derive a timing control signal. Front end circuitry 320 is coupled to Equalizer 330 via output baseband signal 390.

Equalizer 330 receives baseband signal 390 and removes distortions from it. Such distortions may be the result of inter-symbol interference as modeled in multipath signals 160, noise processes introduced in Tuner and Analog Front End 220 or Front End Circuitry 320, adjacent channel interference into broadcast signal 120 and hence coupled into antenna 150, and inaccuracies in transmitter 110, among other processes which distort the desired, encoded signal itself, or its statistics. Equalizer 330 may use a variety of architectures and algorithms, and direct or indirect equalization methods—see S. U. H. Qureshi, “Adaptive Equalization,” Proceedings of the IEEE, vol. 73, no. 9, pp. 1349-1387, September 1985 for a survey of equalization approaches. Direct methods solve for an equalizer setting derived from the data itself, while indirect equalization methods rely on a channel estimate to set the equalizer parameterization. Both direct and indirect equalizers are applicable to both single-carrier and multi-carrier signals. Hence, equalizer 330 receives input signal 385 from Channel Identification (CID) block 365. Input signal 385 contains a channel estimate, which can be used in equalizer 330 when indirect equalization methods are employed. Equalizer 330 produces control signal 380, shown in phantom. Control signal 380 may contain timing or carrier adjustments, for example, based on a variety of known methods, using pilot tones or symbol estimates. The equalized signal 395 has distortions removed, limited by the ability of equalizer 330, and is coupled to Forward Error Correction (FEC) block 340.

FEC 340 further removes distortions of the equalized signal 395 by exploiting the channel coding done to the data signal prior to broadcast. FEC 340 typically tries to minimize the BER of the output signal 265. See S. H. Lin and D. J. Costello, Jr., Error Control Coding: Fundamentals and Applications, Upper Saddle River, N.J.: Prentice Hall, 2004 for discussions of error correction techniques applicable to DTV signals. Output signal 265 from FEC 340 is coupled to media processor 240.

5

### Least Squares Channel Estimation

When a sequence of training signals is periodically inserted into the transmitted signal, a channel impulse response can be estimated via a least squares algorithm in CID block 365 to be used for indirect equalization. The least squares estimate is derived by recognizing that at some time n corresponding to the transmission of the training sequence symbols, the baseband baud-spaced samples r(n) 390 are well modeled by the following equation

$$\underbrace{( \begin{matrix}r ( n ) \\ r ( n - 1 ) \\ ⋮ \\ r ( n - K )\end{matrix} )}_{R} = \underbrace{( \begin{matrix}{t}_{L} & {t}_{L - 1} & ⋯ & {t}_{L - N + 1} \\ {t}_{L - 1} & {t}_{L - 2} & ⋯ & {t}_{L - N} \\ ⋮ & ⋮ & & ⋮ \\ {t}_{L - K} & {t}_{L - K - 1} & ⋯ & {t}_{0}\end{matrix} )}_{T} \underbrace{( \begin{matrix}{c}_{0} \\ {c}_{1} \\ ⋮ \\ {c}_{N - 1}\end{matrix} )}_{C} + \underbrace{( \begin{matrix}w ( n ) \\ w ( n - 1 ) \\ ⋮ \\ w ( n - K )\end{matrix} )}_{W} \qquad ( 1 )$$

where {t₀, . . . ,t_{L}}, are the training sequence symbols, {c₀, . . . , c_{N-1}}, are the channel impulse response coefficients and w(n) is additive white Gaussian noise from the transmission channel. The least squares (LS) estimate for the channel impulse response is given by

$$\hat{C} = \underbrace{{( {T}^{H} T )}^{- 1}}_{M} \underbrace{{T}^{H} R}_{U} .$$

for some K≧N (see “Adaptive Filter Theory”, by S. Haykin, Prentice-Hall, 1986, Englewood Cliffs, N.J.). Setting K=L−N+1 makes use of all training sequence symbols. Matrix T^{H}T is known as a deterministic correlation matrix and is derived in equation (1) by windowing the known training sequence symbols via the covariance method. Other windowing methods described in “Adaptive Filter Theory” assume the data is zero outside the window of known training symbols and could be used as an alternative to the model in equation (1). We shall call matrix M=(T^{H}T)⁻¹ the inverse correlation matrix.

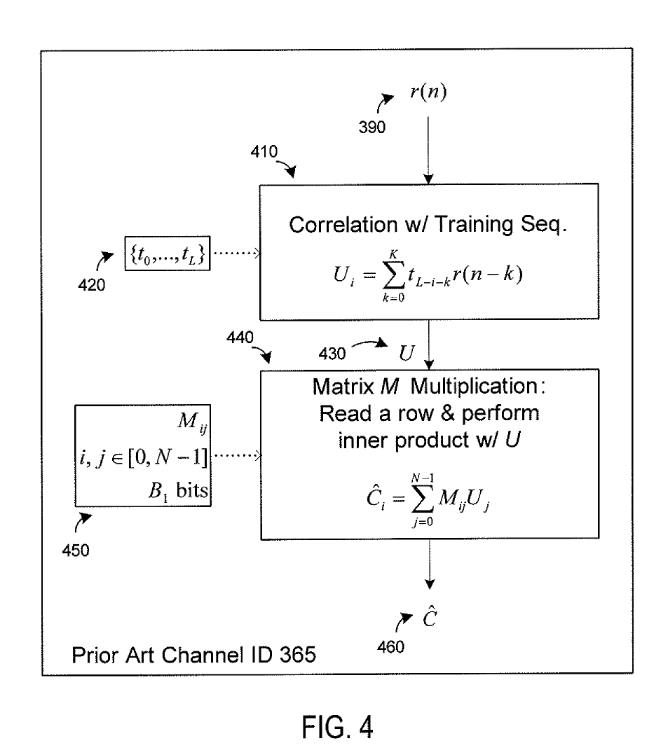

FIG. 4 shows a typical prior art CID block 365. Training symbols {t₀, . . . , t_{L}} 420 and a N×N matrix M 450 are stored in the receiver for calculation of the LS estimate. The calculation can be done in two steps. The first step correlates the training sequence with the received samples r(n) 390 yielding vector U 430 as per the cross-correlation 410

$${U}_{i} = {\sum }_{k = 0}^{K} {t}_{L - i - k} r ( n - k ) , i = 0 … N - 1.$$

The second and final step performs the matrix multiplication in matrix multiplication 440

$${\hat{C}}_{i} = {\sum }_{j = 0}^{N - 1} {M}_{ij} {U}_{j} , i = 0 … N - 1$$

yielding channel estimate Ĉ 460. Typically, each coefficient Ĉᵢ of channel estimate Ĉ̂460 is generated via the inner product of each row of M with U as in the summation above.

In a fixed-point implementation the elements of inverse correlation matrix M are stored using p -bits of precision plus a sign bit so that the data ranges from −2^{P} to 2^{P}−1. Thus, matrix M uses B₁=(p+1)N² bits of memory. For large N and p the amount of data storage can be prohibitively costly. For example, with p=15 and N=512, the matrix M uses 4 Mbits of memory.

### Inverse Correlation Matrix Compression

The current application is directed to providing a method of reducing the storage used for an inverse correlation matrix M by exploiting the structure of its elements. The first important fact about M is that it is symmetric, i.e. Mᵢⱼ=Mⱼᵢ. This fact has the immediate potential for cutting the storage used for matrix M by a factor of 2.

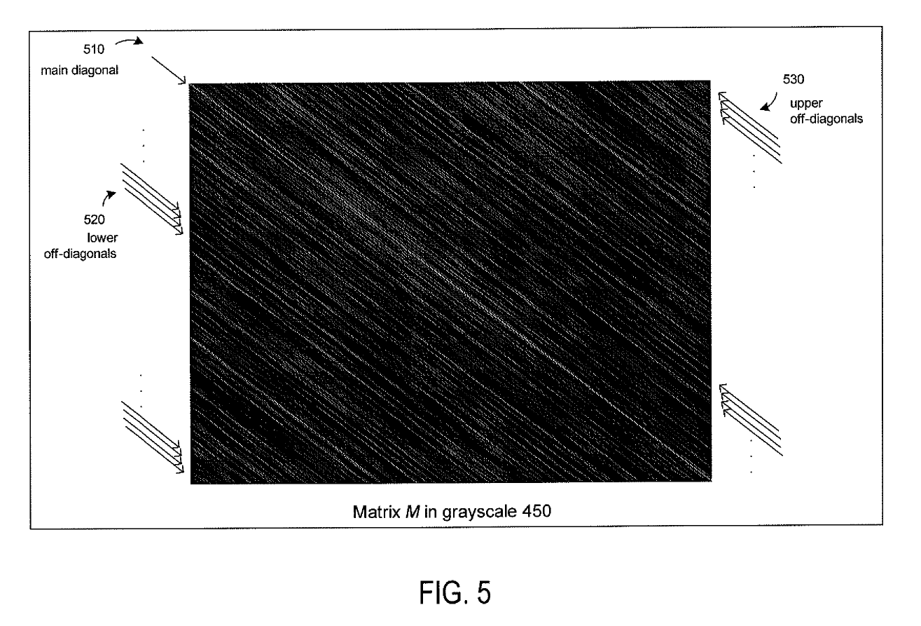

A grayscale representation of matrix M 450 is shown in FIG. 5 for the length 1424 training sequence used in ATSC M/H transmission (see “ATSC-Mobile DTV Standard, Part 2—RF/Transmission System Characteristics,” Document A/153 Part2:2009, October 2009, Advance Television Systems Committee, available with all parts in a single pdf file online at http://www.atsc.org/cms/standards/a153/a 153-Part-2-2009.pdf) and for a channel estimate length N=512. In FIG. 5 the brightness of the pixels is proportional to the magnitude of its elements. Notice that the brightness, and therefore the magnitude of the elements, is fairly constant down the main and off-diagonals. The reason for this feature is that training sequences are typically chosen to be uncorrelated. Thus, as the length of a well-designed training sequence increases, matrix M 450 approaches the identity matrix. The current application is directed to exploiting this feature by proposing a differential encoding compression scheme down the main diagonal 510 and down each off-diagonal. For the purpose of clarity, the detailed description discusses use of the upper off-diagonals 530 of the matrix. However, either upper off-diagonals 530 or lower off-diagonals 520, or a combination of upper and lower off-diagonals may be used.

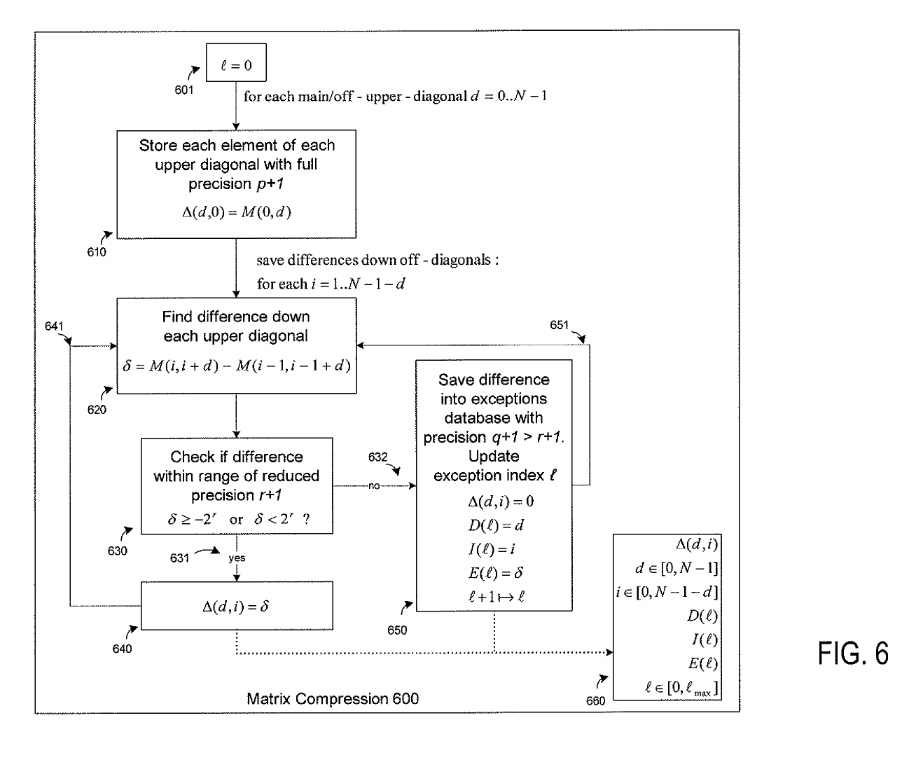

FIG. 6 describes lossless compression method 600 which yields a database 660 for compressed matrix M data. The method starts at step 601 where an exception counter l is initialized to zero. The subsequent steps 610 through 650 are performed for every matrix diagonal d=0 . . . N−1, where d=0 is the main diagonal and all others are upper diagonals. Step 610 stores matrix M row 0, element d with full precision p+1 into database Δ. Next, steps 620 through 650 are performed for each element i=1 . . . N−1−d of diagonal d where row index i is also the index that moves down the diagonal. In step 620 the difference S between the current element of the diagonal and the previous element of the diagonal is calculated. Step 630 checks if that difference can be represented by a reduced precision r+1. If so, the procedure moves along path 631 to step 640 and stores the difference δ into database Δ via output 642. Step 640 and returns to step 620 via path 641 to handle the next element of the diagonal. If not, the procedure moves along path 632 to treat the difference as an exception in step 650.

Step 650 handles exceptions, which are differences down the diagonal that cannot be represented by a reduced precision, by storing the difference in some other precision q+1>r+1. In step 650 the data into database A is forced to zero and the diagonal index d , row index i and difference δ are stored into exception database vectors D, I and E respectively, under exception index l. The data is kept in database 660 via output 652. The exception index is incremented in step 650 and the procedure continues by returning via path 651 to step 620. The final exception count lₘₐₓ is also included in database 660 via output 652.

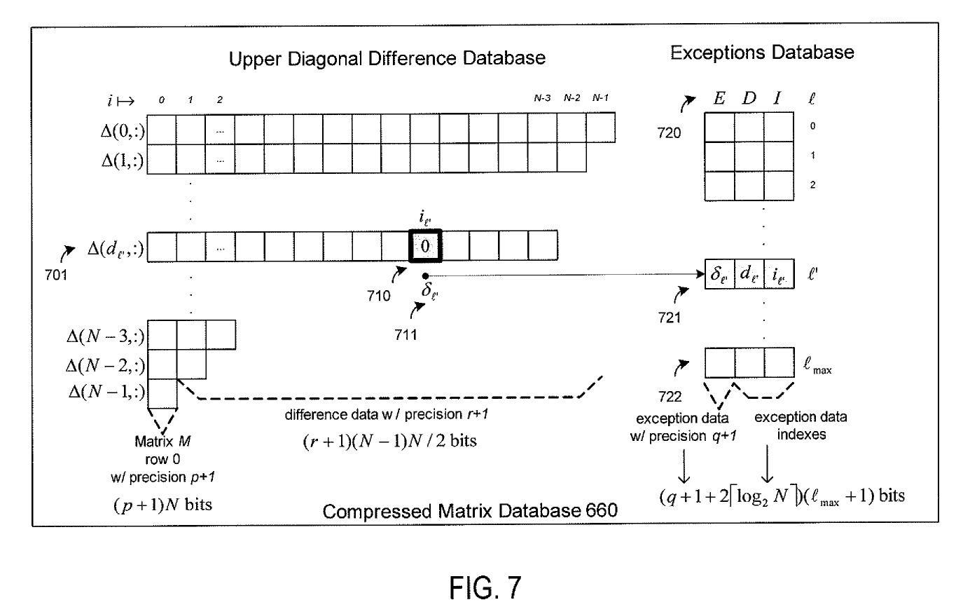

FIG. 7 illustrates the structure of database 660. The data for the first row of matrix M is stored with full precision p+1 in the leftmost column of database Δ701. The difference data down each diagonal is stored with reduced precision r+1 and is represented by the rows of Δ701. As an example, in FIG. 7, the difference δₑₗ 711 is treated as an exception, therefore forcing Δ(d ₑₗ,iₑₗ) to zero in storage element 710. All the information for the exception is stored with precision q+1>r+1 in the exceptions database 720 in storage element 721. The last element in database 720 is element 722 with exception index lₘₐₓ. Thus, the total storage in bits for this scheme is given by

$${B}_{2} = \underbrace{( p + 1 ) N}_{\begin{matrix}first - row full \\ precision data\end{matrix}} + \underbrace{( r + 1 ) ( N - 1 ) N / 2}_{\begin{matrix}upper diagonal \\ reduced precision \\ difference data\end{matrix}} + \underbrace{( \overbrace{q + 1}^{{difference data}^{exceptions}} + \overbrace{2 ⌈ {log}_{2} N ⌉}^{\begin{matrix}exceptions \\ index data\end{matrix}} ) ( {l}_{max} + 1 )}_{exceptions database} .$$

### Examples

An example of this compression method is provided in Tables 1 through 4. Table 1 is a 6-by-6 M matrix which is being compressed using the parameters in Table 2. The resulting databases are given in Table 3 and Table 4. Table 2 shows that the uncompressed matrix uses 360 bits of storage while the matrix compressed by the method in FIG. 6 only uses 77 bits of storage.

TABLE 1
Small inverse correlation matrix for compression example
(example of matrix M 450)

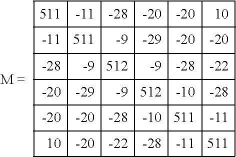

TABLE 2
Parameters for compression example

| | |
|---|---|
| N | 6 |
| ┌log₂ N┐ | 3 |
| p + 1 | 10 |
| r + 1 | 1 |
| q + 1 | 2 |
| lₘₐₓ + 1 | 4 |
| B₁ | 360 bits |
| B₂ | 77 bits |

TABLE 3
Example of difference database 640 for
compression example (exceptions are highlighted in yellow)

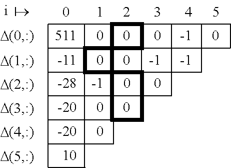

TABLE 4
Example of exceptions database 660 for compression example
E D I l

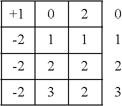

Another example is provided in Table 5, which includes the parameters for compression of a much larger 512-by-512 matrix. In this case the compression reduces the full precision from 2 Mbits to 448 Kbits. In both examples from Tables 1-4 and Table 5 the compression ratio is better than 4:1.

TABLE 5
Parameters for compression of a larger inverse correlation matrix.

| N | 512 | |
|---|---|---|
| ┌log₂ N┐ | 9 | |
| p + 1 | 8 | |
| r + 1 | 3 | |
| q + 1 | 5 | |
| lₘₐₓ + 1 | 3000 | |
| B₁ | 2 | Mbits |
| B₂ | 448 | Kbits |

### Matrix Reconstruction and Multiplication

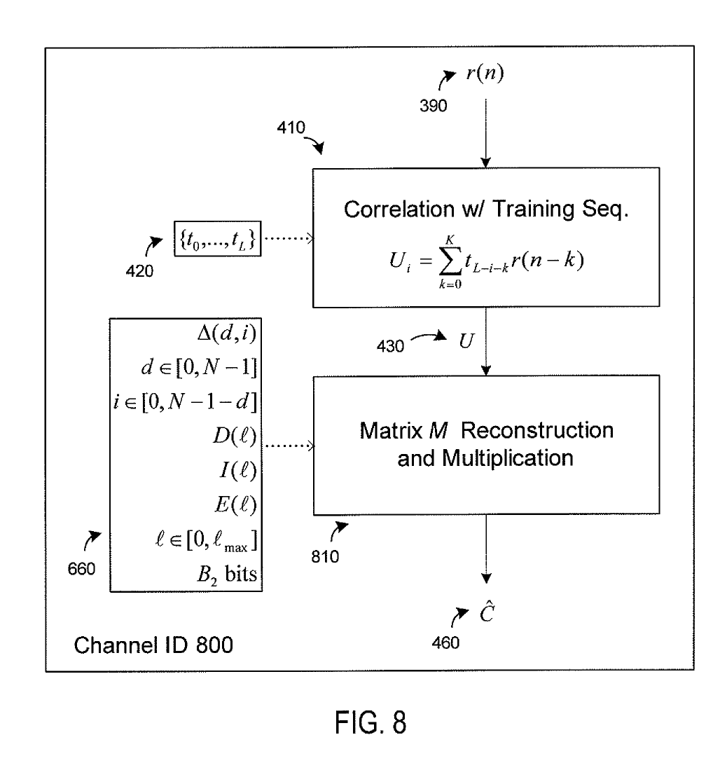

FIG. 8 illustrates a novel approach to channel identification by replacing CID block 365 introduced in FIG. 3 and FIG. 4 with CID block 800. Training symbols {t₀, . . . , t_{L}} 420 are stored in the receiver for calculation of the LS estimate, but matrix M is not stored with full precision as in FIG. 4. Instead, the full precision representation of the matrix is replaced by its compression data in database 660 from FIG. 6. The correlation between the training sequence 420 and the received samples r(n) 390 yielding vector U 430 is performed in cross-correlation block 410. Block 810 performs a joint reconstruction of each diagonal of matrix M and diagonal-wise multiplication of the reconstructed diagonals with vector U. The results are accumulated over all diagonals to generate the channel estimate Ĉ 460.

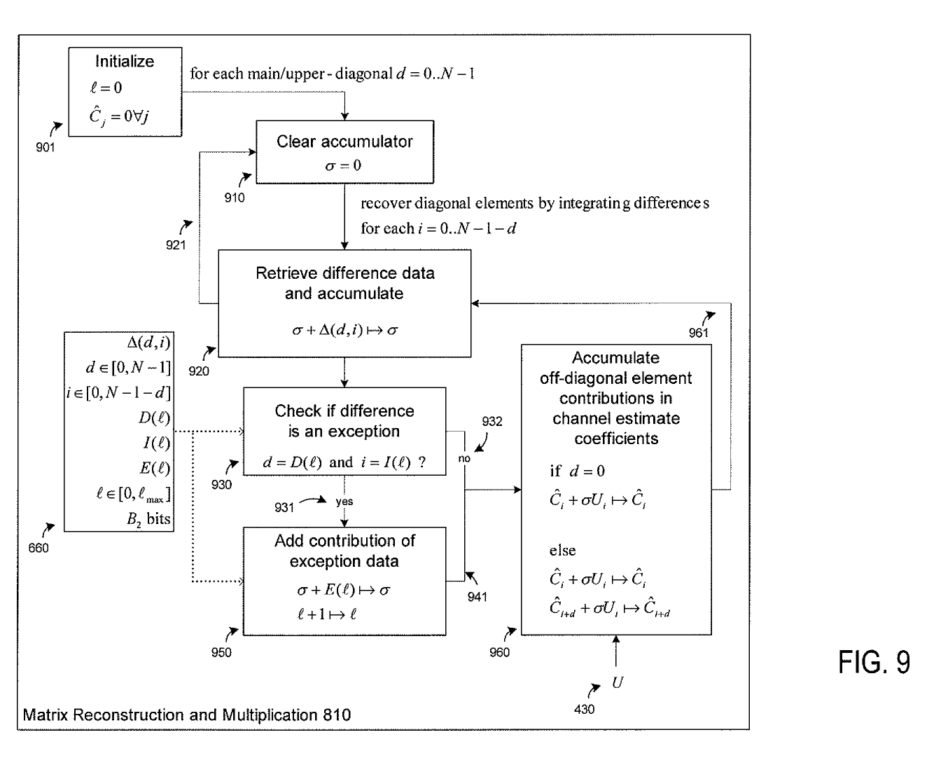

FIG. 9 describes the process of reconstruction and diagonal-wise multiplication in block 810 of FIG. 8. The method starts in step 901 where the exception counter l and the channel estimate Ĉᵢ coefficients are cleared. The subsequent steps 910 through 960 are performed for each diagonal d=0 . . . N−1. In step 910 the accumulator o which will contain the restored matrix element σ=M_{di} is cleared. Next, steps 920 through 960 are performed for each i=0 . . . N−1−d. Step 920 increments accumulator a by the reduced precision data Δ(d, i) from database 660. Step 930 checks if element (d, i) is an exception by comparing to the current exception indexes (D(l),I(l)) from database 660. If there is a match, path 931 is followed to step 950 where accumulator a is incremented by the current exception difference E(l), also from database 660. The exception counter l is incremented at that point. Path 941 is followed to step 960. If there is no match for the current exception at step 930, path 932 is followed to step 960, skipping step 950.

In step 960 the channel estimate coefficients are calculated by accumulating the product of the diagonals and the corresponding elements of vector U 430. For the main diagonal, when d=0 , a single multiply-accumulate is performed. For all other diagonals d=1 . . . N−1, however, an upper and lower multiply-accumulate is performed to account for the contribution of the upper and lower diagonals. The procedure then returns to step 920 via path 961 and continues the process until all the elements of the diagonal are accounted for. When all the elements of the diagonal are reconstructed and used in steps 920 through 960, the process moves from step 920 to step 910 via path 921 and the process of steps 910 through 960 starts again for the next diagonal d.

Several variations of the combined compression and reconstruction/multiplication procedures are possible. As previously mentioned, the lower diagonals or a combination of the upper and lower diagonals can be used in the process. The process is described on a diagonal-by-diagonal basis, but hardware implementations may be more efficient on a block basis where multiple diagonals are treated in parallel. Also, different precisions may be used for different diagonals. For example, the elements of the main diagonal tend to be positive and larger in amplitude than the other elements of the matrix so the sign can be dropped and the range of the precision can be manipulated for further reduction in memory. Another example is the exception database, which can store the actual data from the matrix instead of difference data. The memory usage may be slightly higher in this case but the extra addition in step 950 is avoided. Finally, the detailed description discusses a differential encoding method of compressing the diagonal data but a myriad of other compression and reconstruction methods of processing the diagonal data could be used.

One skilled in the art would understand that the various functions of signal processing described herein may include scaling, change of sign, or similar constant modifications that are not shown or discussed for simplicity. One skilled in the art would realize that such modifications can be readily determined or derived for the particular implementation. Thus, the described various functions of signal processing may be subject to such modifications, and are not limited to the exact forms or descriptions presented herein.

As would be apparent to one skilled in the art, the various functions of signal processing may be implemented with circuit elements or may also be implemented in the digital domain as processing steps in a software program. Such software may be employed in, for example, a digital signal processor, micro-controller, or general-purpose computer.

The presently claimed invention can be embodied in the form of methods and apparatuses for practicing those methods. The presently claimed invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. In a device capable of receiving a signal, a method of calculating a channel estimate, the method comprising:
reconstructing a diagonal of a matrix from compressed data;
multiplying the diagonal with the corresponding part of a vector to form a product;
accumulating the product to form the channel estimate.

2. The method of claim 1 wherein the signal is in accordance with ATSC A/153 digital television standard.

3. The method of claim 1 wherein the signal is in accordance with ATSC A/53 digital television standard.

4. The method of claim 1 wherein the part of a vector is derived from the correlation of a baseband signal with a training sequence.

5. The method of claim 1 wherein the step of reconstructing a diagonal of matrix comprises accumulating the compressed data.

6. The method of claim 5 further comprising the steps of:
identifying if the compressed data is an exception;
adding the contribution of the exception to the channel estimate.

7. The method of claim I wherein the step of accumulating the product to form the channel estimate comprises accumulating off-diagonal element contributions.

8. An apparatus for calculating a channel estimate from a digital communications signal, the apparatus comprising:
a correlator that produces correlations of a baseband signal with a training sequence;
a database of off-diagonal difference data for an inverse correlation matrix;
a database of exceptions;
a first accumulator for accumulating the difference data to form a first matrix diagonal;
an exception handler for adding exceptions to the intermediate matrix diagonal to fault a second matrix diagonal;
a second accumulator for accumulating the product of a part of the correlations with the second matrix diagonal to form the channel estimate.

9. The apparatus of claim S wherein the signal is in accordance with ATSC A/153 digital television standard.

10. The apparatus of claim 8 wherein the signal is in accordance with ATSC A/53 digital television standard.

11. The apparatus of claim 8 wherein the difference database comprises data with a first number of precision bits and the exception data comprises data with a second number of precision bits.

12. A digital communications receiver comprising the apparatus of claim 8 wherein the channel estimates are provided to an equalizer for further processing of the baseband signal.

13. A digital communications receiver comprising:
a correlator that produces correlations of a baseband signal with a training sequence;
a database of off-diagonal difference data for an inverse correlation matrix;
a database of exceptions;
a first accumulator for accumulating the difference data to form a first matrix diagonal;
an exception handler for adding exceptions to the intermediate matrix diagonal to form a second matrix diagonal;
a second accumulator for accumulating the product of a part of the correlations with the second matrix diagonal to form a channel estimate; and
an equalizer with coefficients derived from the channel estimate, wherein the equalizer processes the baseband signal to generate a signal for further decoding.

14. An integrated circuit having a channel estimation circuit, the integrated circuit comprising:
a correlator that produces correlations of a baseband signal with a training sequence;
a database of off-diagonal difference data for an inverse correlation matrix;
a database of exceptions;
a first accumulator for accumulating the difference data to form a first matrix diagonal;
an exception handler for adding exceptions to the intermediate matrix diagonal to form a second matrix diagonal; and
a second accumulator for accumulating the product of a part of the correlations with the second matrix diagonal to form a channel estimate.
